(19) United States
(12) Patent Application Publication
(10) Pub. No.: US 2008/0059268 A1
(43) Pub. Date: Mar. 6, 2008

(54) Method and system for advanced credentialing and registration for health care professionals

(76) Inventors: Jun Davantes, Pewaukee, WI (US); Patrick Greischar, Whitefish bay, WI (US); Robert Hedgcock, Oconomowoc, WI (US)

Correspondence Address: Jun Davantes, W271N2617 Orchard Lane, Pewaukee, WI, 63072, US

(21) Appl. No.: 11/512,889

(22) Filed: Aug. 29, 2006

(51) Int. Cl. G05B 19/418

(52) U.S. Cl. 705/8

(57) ABSTRACT

The present invention provides a method and a system for storing information about volunteers and other medical personnel along with a credential level associated with each volunteer or medical personnel. The credential level is generated on the basis of information provided by the volunteer. The invention also provides for sharing the volunteer information with one or more users that are associated with one or more medical facilities or regions that have a medical emergency. The information is shared on the basis of the access levels that are assigned to the users and to the stored volunteer information.

### BACKGROUND OF THE INVENTION

1. Field of the Invention

The present invention relates generally to a personnel registration and credentialing system. Further, the present invention relates to a computer implemented system and method for medical personnel to register and report at the site of medical emergencies and disasters.

2. Description of the Prior Art

A multiple-victim disaster can overwhelm ill-prepared medical facilities. It puts pressure on the existing facilities. Medical personnel are required to reach the site or multiple sites of the emergency and take control. In most cases, the number of medical personnel required to provide relief is always greater than the number of medical personnel available in the vicinity of the region where the disaster has occurred. This causes the region to request help from neighboring regions. The help may be in terms of medical volunteers, medical supplies, facilities, and other support needed to handle the disaster. Medical volunteers may be required to provide relief to the victims of the disaster, provide medical support to the medical professionals present at the site or sites of the disaster, help in search and rescue missions or provide help and support as required.

Regions affected by the disaster may need to request volunteers from other regions. Some organizations maintain a list of volunteers in their respective regions. These organizations are then contacted and help is requested from the registered volunteers. These organizations in turn contact their volunteers and request assistance. This process may be time consuming and there may be a significant time gap between the disaster affected region requesting help and the volunteers reporting to the region.

Another problem that the disaster affected regions may face is the lack of trained volunteers that may report to the site or sites of the disaster. Every disaster requires volunteers that are trained to handle that type of disaster and medical emergencies that result from that disaster.

Volunteers from other regions that report at the site or sites of a medical emergency should be deployed based on their training and expertise. It is not easy for the disaster relief personnel to manage the disaster and also to manage the deployment of the volunteers. In successfully deploying each of the volunteers, the personnel need to first collect information from the volunteers regarding their training and professional certification and experience. They then need to make a decision on how capable each of the volunteers is to handle the assigned task.

After the volunteers are deployed at the site or sites of the disaster, they should be tracked to ensure that only certain trained volunteers have access to regions that they are trained to handle. For example, medical nurses, doctors, etc. should be allowed at medical camps and not search and rescue workers.

From the above discussion, it is clear that there is a need for a system that will enable disaster affected regions to quickly find and deploy suitable volunteers. Further, the system should be able to generate a credential level for the registered volunteers and ensure that volunteers are provided access to areas for which they have credentials and have been certified access. Further, the system should be compliant with the federal guidelines of Emergency System of Advance Registration of Volunteer Health Professionals (ESAR-VHP) and National Incident Management System (NIMS).

### SUMMARY OF THE INVENTION

A first aspect of the present invention is to provide a method for providing a credential level of at least one volunteer responding to a medical emergency in a region to a user; the method comprising the steps of providing access to a database of volunteers, verifying that the at least one volunteer responding to the medical emergency exists in the database of volunteers, and confirming a credential level for the at least one volunteer responding to the medical emergency.

A second aspect of the present invention is to provide a method for providing at least one volunteer at the site of a medical emergency in a region, the method comprising the steps of storing volunteer information in a database, the volunteer information stored along with access rights specifying at least one other region that can access the information, sending a request to at least one volunteer from the list of volunteers that can be accessed by the region of the medical emergency to report at the site of the medical emergency, the at least one volunteer responding to the request by being present at the site of the medical emergency, and generating a credential level of the at least one volunteer that has responded to the request.

A third aspect of the present invention is to provide a method for providing at least one volunteer at the site of a medical emergency in a region, the method comprising the steps of storing volunteer information in a database of volunteers, the volunteer information stored along with access rights specifying at least one other region that can access the volunteer information, generating and storing a credential level for the at least one volunteer, providing the region affected by the medical emergency access to a list of volunteers, the list of volunteers generated from the database of volunteers, the region not initially having access rights to the list of volunteers, sending a request to at least one volunteer from the list of volunteers, to report at the site of the medical emergency, the at least one volunteer responding to the request by being present at the site of the medical emergency, and providing a credential level of the at least one volunteer that has responded to the request.

Yet another aspect of the present invention is to provide a method for generating a credential level for at least one volunteer responding to a medical emergency, the method comprising the steps of receiving information about the at least one volunteer from a database storing said information; the information comprising at least one element of ESAR-VHP elements, calculating a score for the at least one element, combining the individual scores to obtain a final score, comparing the final score to predetermined threshold levels to obtain a credential level, and providing the calculated credential level for generating an identification badge, the identification badge communicating the credential level.

Still another aspect of the present invention is to provide a system for providing a credential level to at least one volunteer responding to a medical emergency in a region, the system comprising at least one server having a first database; the first database storing a list of volunteers, at least one client for accessing the database, the client retrieving at least one volunteer information and providing a credential level, and a network connecting the server and the client.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic view of the overall system of the present invention, in accordance with an embodiment of the present invention.

FIG. 2 is a schematic view of the system for providing clients with volunteer information including credential information, in accordance with an embodiment of the present invention.

FIG. 3 is a flowchart depicting the steps of recording and verifying volunteer information, in accordance with an embodiment of the present invention.

FIG. 4 is a flowchart depicting the steps involved in selecting and registering volunteers and health care professionals for a medical emergency, in accordance with an embodiment of the present invention.

FIG. 5 is a flowchart depicting the steps involved in providing one region access to volunteer list of another region, in accordance with an embodiment of the present invention.

FIG. 6 is a flowchart depicting steps of generating a credential level for a volunteer who is a physician, in accordance with an embodiment of the present invention.

### DETAILED DESCRIPTION OF THE PREFERRED EMBODIMENTS

The present invention provides a medical personnel registration and credentialing system and method with medical personnel related data to provide credentials for the medical personnel. This system is designed for use remotely or at site of a medical emergency. A medical emergency can be defined as a situation where more than one people are injured. There may be some damage to property also in a medical emergency. Examples of medical emergencies include accidents involving vehicles and humans and natural disasters such as hurricanes, tornadoes, earthquakes, etc. The medical emergency may be at a single site or may affect multiple sites that are spread across regions, such as towns, cities, counties, states and even countries.

During any medical emergency, additional medical professionals may be required to provide relief and medical help to those injured. Sometimes, the region, or regions, that are suffering from the medical emergency may not have the medical professionals required for the emergency. In such a case, the region may request help from other regions, usually neighboring ones. The volunteers from other regions are sent requests to report to the site of the emergency. This is usually done by the system through an alert in the form of an email or a message. At the site of the emergency, the reporting volunteers are then verified. The verified volunteers may also be given an identification badge to easily identify them and their respective skills so that they are free to move about regions or areas in which they can be of help.

The system maintains a database of medical personnel. The medical personnel include persons who have registered with the database, such as volunteers; personnel in the National Incident Management System's (NIMS) database, such as municipal employees; and the like. The medical personnel that have defined above will be referred to as volunteers in this application for sake of convenience and clarity. Volunteers from that database can be called upon during a medical emergency. This list is protected such that all users of the system do not have access to information about all the volunteers in the system. The users of the system are associated with a specific region, medical facility and the like. Each user is allowed to view volunteer information that is associated with their specific region, medical facility and the like. In an embodiment of the present invention, a user of the system located in a State can only view information of volunteers that are in or around that state. The volunteers that any user is authorized to view can be configured on an individual volunteer basis or a group basis by one or more system administrators.

Volunteers can add their information to the volunteer database. This is provided through a web interface. Once a volunteer has entered his or her information in the database, one or more system administrators should verify that the information entered by the volunteer is correct and accurate. Based on this information, the system administrator can generate a credential level for the volunteer or use a predetermined credential level. After the information has been verified, the volunteers are activated. This means that other users searching for volunteers to respond to a medical emergency will be able to find this newly added volunteer in the database. Additionally, system administrators can setup volunteer access rules that will specify who can find this newly added volunteer information.

Volunteer access rules are based on the region of a user searching for volunteers, the medical facility that the user is associated with or a medical emergency that the user is associated with. In an embodiment of the present invention, a user that is associated with a particular region can view volunteers that have been assigned to that region by a system administrator. The user can then select one or more volunteers and send a request to the selected volunteers to help in a medical emergency. Only those volunteers to whom the request has been sent will be able to verify themselves at the site of the medical emergency, which means that the volunteers have been previously sent a request to report at the medical emergency and that the volunteers' information is present in the system.

Once a volunteer, who has been requested to help at the site of the medical emergency, presents himself or herself at the site, a credential level is provided to the volunteer. This credential level has already been generated and stored in the system, on the basis of the volunteer information that is stored in the volunteer database. The credential level signifies the authority the volunteer has or the qualifications of the volunteer. For example, a volunteer who is a doctor certified to handle surgeries will have a credential level that will enable him to provide emergency medical help and to perform surgeries at the site of the emergency. Thus the credential level helps to identify a volunteer at the site of the emergency. This credential level may be provided to the volunteer in the form of a printed identification badge, or an identification badge that may be machine readable, such as a barcode, radio frequency identification (RFID) tag and a smart card.

The volunteer credentials are generated by a method that is compliant with the federal standard for Emergency System for Advanced Registration of Volunteer Health Professionals (ESAR-VHP). This guideline specifies storing volunteer information having multiple ESAR-VHP elements. These elements are then scored individually and a total score is calculated to arrive at a credential level.

In another embodiment of the present invention, a system administrator assigns volunteers to a medical emergency. These volunteers initially have not been assigned with the region that is associated with the medical emergency. Once the system administrator assigns these volunteers to a medical emergency, a request is automatically sent to the volunteers to report at the site of the medical emergency. Now these volunteers will be able to verify themselves at the site of the medical emergency.

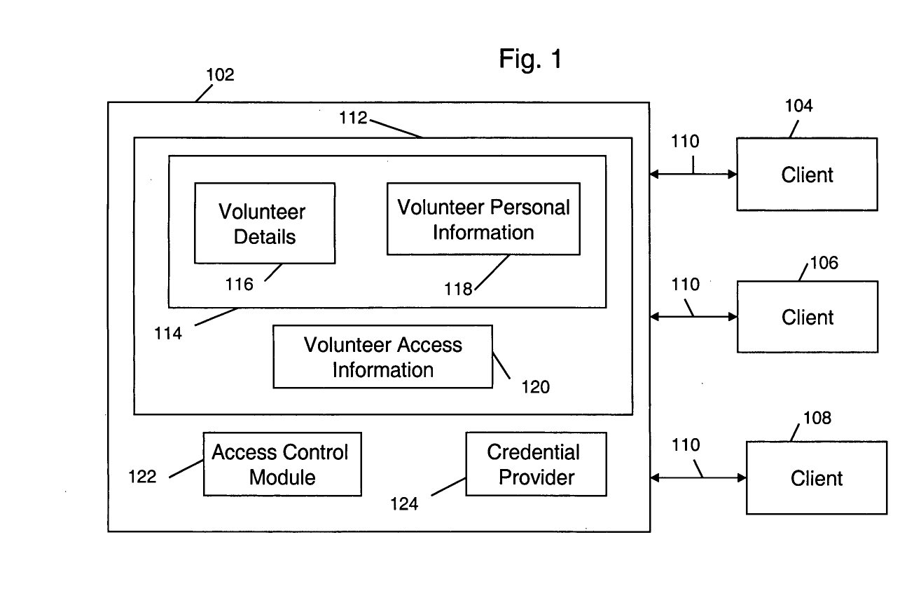

Referring now to the drawings in general, the illustrations are for the purpose of describing a preferred embodiment of the invention and are not intended to limit the scope of the present invention. FIG. 1 is a schematic view of the overall system of the present invention, in accordance with an embodiment of the present invention. Server 102 is connected to multiple clients 104, 106 and 108 via network 110. Server 102 may be any personal computer having one or more processing means, storage means and memory means, as commonly known in the art. Clients 104, 106 and 108 can be personal computers, laptop computers, tablet PCs, mobile phones and other devices known in the art capable of accessing a website or running a standalone application. Clients 104, 106 and 108 access server 102 via network 110. Network 110 can be a local intranet, the internet, and the means of access the server 102 may be wired, wireless or via a mobile network.

Server 102 has database 112 residing on it. Database 112 is a database having means for storing data and organizing data into tables. Commercial examples of database 112 include Microsoft® SQL Server and Oracle®. In another embodiment of the present invention, database 112 may be separate from server 102. Database 112 may be on a second server that is connected to server 102 by means commonly known in the art.

Database 112 stores volunteer information 114 for one or more volunteers. In one embodiment of the present invention, database 112 is compatible with NIMS. In another embodiment, database 112 is compatible with Federal Information Processing Standards (FIPS) Publication 201-1 for Personal Identity Verification for Federal Employees and Contractors. Volunteer information 114 further comprises volunteer details 116, volunteer personal information 118 and volunteer access information 120. Volunteer details 116 specify certain elements that are essential in determining the credential level of the volunteer. Volunteer personal information 118 stores information such as name, address, contact number, email address, zip code, training background and the like. Volunteer access information 120 is used to determine if users can access volunteer details 116 and volunteer personal information 118. It also determines if users can search for a volunteer based on volunteer details 116, volunteer personal information 118. In one embodiment of the present invention, volunteer access information 120 stores a list of regions to which the volunteer details 116 and volunteer personal information 118 will be visible. In another embodiment of the present invention, volunteer access information 120 stores a list of users that can view volunteer details 116 and another list of users that can view volunteer personal information 118. It will be apparent to one skilled in the art that the two lists of users may have some overlap.

Server 102 further comprises access control module 122. Access control module screens clients 104, 106 and 108 accessing server 102 and provides access to volunteer details 116 and volunteer personal information 118 on the basis of the volunteer access information 120. When a client requests to view volunteer information, access control module 122 first determines if client has access to volunteer information by matching client information with volunteer access information 120. In another embodiment of the present invention, clients 104, 106 or 108, request to view a list of all volunteers. Access control module 122 retrieves volunteer details 116 and volunteer personal information 118 for all volunteers that have specified access to client 104 in their volunteer access information 120.

Server 102 also comprises credential provider 124 that provides credential information about one or more volunteers to clients 104, 106 and 108. In one embodiment of the present invention, credential provider 124 generates credentials for one or more volunteers by accessing information stored in volunteer details 116. The method of generating credentials is compliant with ESAR-VHP guidelines. In another embodiment of the present invention, credential provider 124 interfaces with an external database, such as a state or national licensing database to import credential information for one or more volunteers.

In another embodiment of the present invention, access control module 122 is not part of server 102, but is part of another server that can communicate with server 102 by means known in the art. In yet another embodiment of the present invention, credential provider 124 is not part of server 102, but is part of another server that can communication with server 102 by means known in the art.

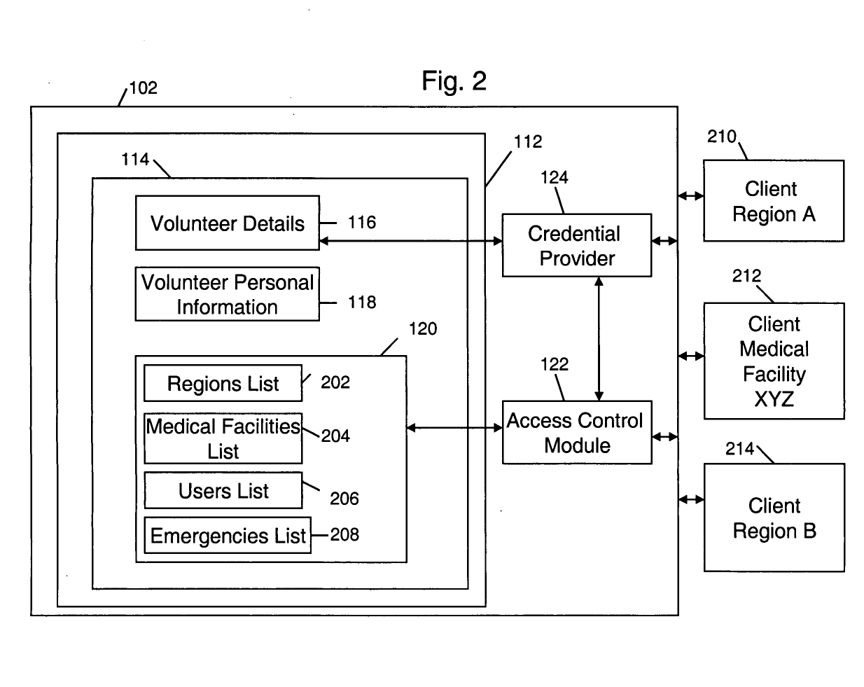

FIG. 2 is a schematic view of the system for providing clients with volunteer information including credential information, in accordance with an embodiment of the present invention. Volunteer access information 120 further comprises a regions list 202, a medical facilities list 204, a user list 206 and an emergencies list 208. These lists specify regions, medical facilities, users and emergencies that can access volunteer details 116 and volunteer personal information 118. A client 210 associated with region A tries to retrieve a list of volunteers. The access control module 122 first determines the region of client 210. Next, access control module 122 retrieves a list of volunteers that have region A in their regions list 202. This list is then passed to client 210. In another embodiment of the present invention, client 212 associated with medical facility XYZ tries to retrieve a credential level of one volunteer. The access control module 122 determines if that volunteer has medical facility XYZ in its medical facilities list 204. In case the medical facility is present in medical facilities list 204, volunteer details 116 for that volunteer are sent to credential provider 124 which in turn provides a credential level, that is previously generated based on the volunteer details 116, and sends it to client 212 along with volunteer personal information 118, if requested. In one embodiment of the present invention, once the client 212 is provided with the credential information, client 212 can generate an identification badge on the basis of credential information and volunteer personal information 118.

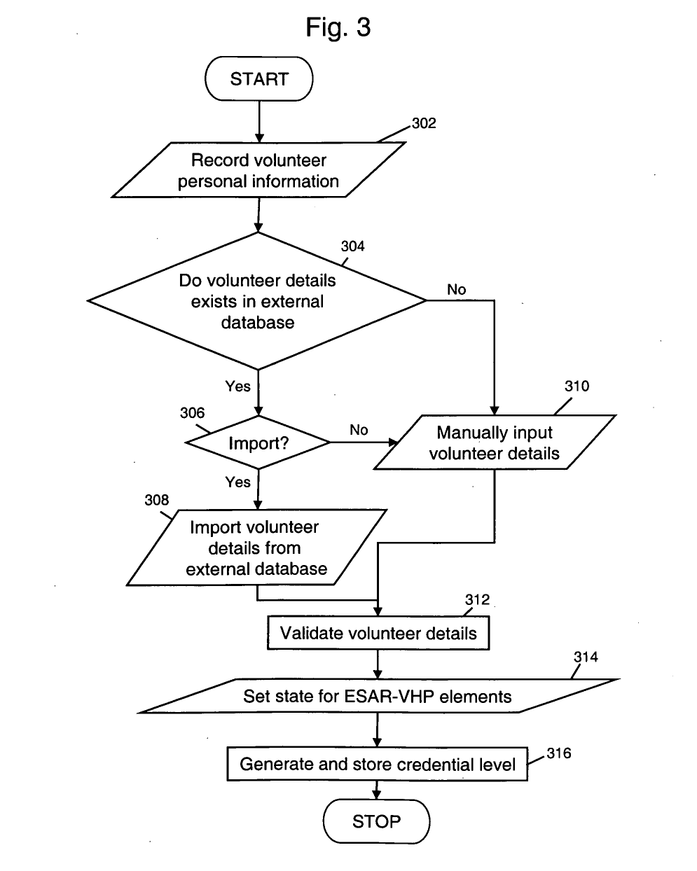

Before volunteers can be requested to report to a medical emergency, the volunteers need to provide their information in the system. This is achieved by providing the volunteers with a web interface in which they can enter their information and the information can be recorded. FIG. 3 is a flowchart depicting the steps of recording and verifying volunteer information, in accordance with an embodiment of the present invention. First a volunteer needs to register with the system and provide certain basic information such as volunteer personal information 118. This is depicted in step 302. At step 304, server 102 checks if volunteer details 116 are stored in one or more external databases. External databases that may be accessed include ESAR-VHP compatible systems, NIMS databases and other databases compatible with FIPS 201 standards. These databases are accessed by means known in the art, such as via a web service. In case volunteer details are present in one ore more external databases, the volunteer is asked if he or she wants to import the information from the database, at step 306. If the volunteer chooses to import volunteer details 116 from the external database, then the information is imported and stored as volunteer details 116, at step 308. In case the information is not present in the external databases, if the external databases are not accessible or if the volunteer chooses not to import the information, then the volunteer is prompted to input information that will be stored as volunteer details 116, at step 310.

Once a volunteer has entered volunteer details 116 or the volunteer details 116 have been imported from one or more external databases, a system administrator is prompted to verify the volunteer details 116 provided by the volunteer, at step 312. The system administrator may be required to verify volunteer details 116 by contacting one or more agencies that can verify the information, or by requesting documents from the volunteer. At step 314, the administrator sets a state for one or more ESAR-VBP elements on the basis of volunteer details 116. Once the states for the ESAR-VHP elements have been set, a credential level is generated for the volunteer and stored in volunteer details 116, at step 316.

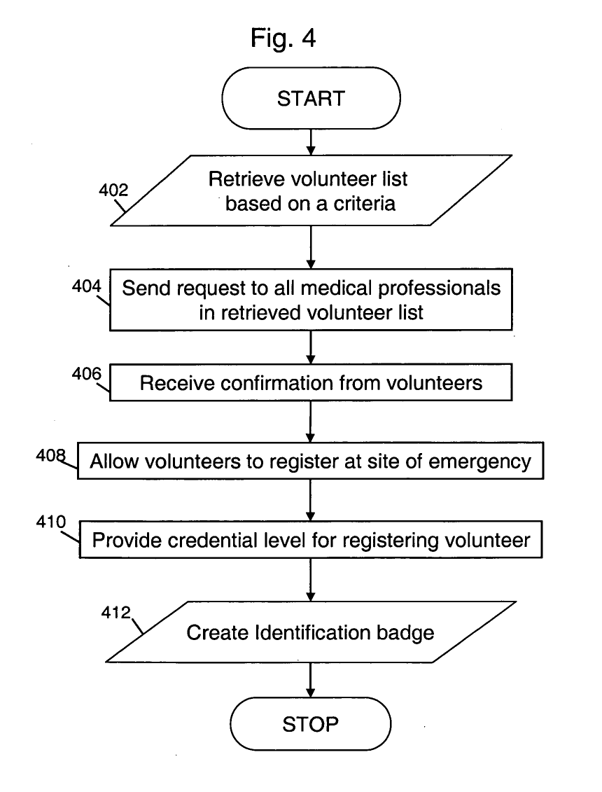

FIG. 4 is a flowchart depicting the steps involved in selecting and registering volunteers and health care professionals for a medical emergency, in accordance with an embodiment of the present invention. First a list of volunteers is retrieved from database 112. This list may be retrieved on the basis of certain volunteer personal details, such as zip code, state registered in or on the basis of volunteer details such as profession, specialty, credential level, training and the like. This is depicted in step 402. In an embodiment of the present invention, this list is further filtered on the basis of other information, such as volunteer professional qualifications, current volunteer status, etc. In step 404, the list is filtered on the basis of volunteer qualifications. Subsequently, all volunteers in the filtered list are then sent a request for helping at the site of the medical emergency. In one embodiment of the present invention, this request is sent electronically via email.

The volunteers can respond to the request by sending an electronic confirmation or rejection. This is received by the system at step 406. Based on the decision of the volunteers, the system can either allow the volunteers to register at the site of the medical emergency, or deny them registration. The volunteers usually register at site of the emergency by presenting a valid photo identification card or any other means for identification known in the art. If they had previously accepted the request sent to them, they will be allowed to register. This is depicted at step 408. A credential level is provided for the registering volunteer at step 410. In an embodiment, the credential level may be provided by a supervisor at the site of the medical emergency. In another embodiment, the credential level may be received from another system or data store, which stores credential levels for a number of volunteers for one or more regions. At step 412, an identification badge is generated for the volunteer on the basis of the credential level. This identification badge may be a printed badge, an electronic badge and the like. In another embodiment, the badge is generated based on FIPS-201 guidelines (Personal Identity Verification) for volunteers and other personnel that are specified under the guidelines. The badge is generated by scoring the elements specified by FIPS-201, similar to that of ESAR-VHP guidelines.

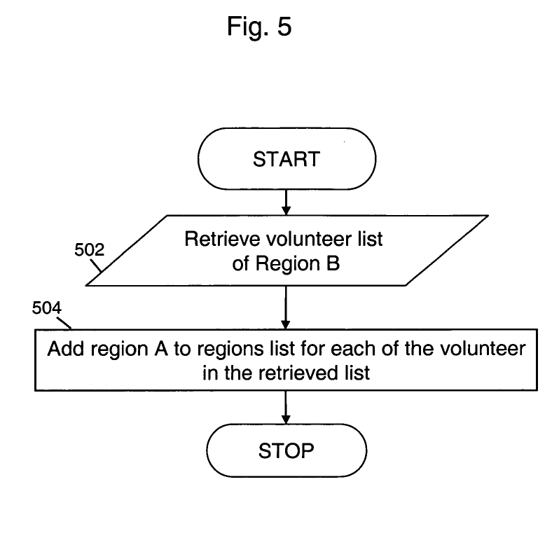

During a medical emergency, a region B may need access to volunteer lists of another region A. In this case, a supervisor that has access to region A will be able to provide region B with volunteer lists of region A. FIG. 5 is a flowchart depicting the steps involved in providing one region access to volunteer list of another region, in accordance with an embodiment of the present invention. A user that has access to volunteer list of region B retrieves the volunteer list of region B in step 502. This user may be an administrator of the system, or another user with equivalent rights. The user than can add region A to the regions list 202 for all the retrieved volunteers. This is depicted in step 504. Now any user associated with region A will be able to view volunteers associated with region B. Therefore, if a volunteer from region B reports to a site of an emergency at region A, then the person verifying the credentials will be able to view the credential or the individual ESAR-VHP or FIPS-201 elements for the reporting volunteers for generating credential levels. In another embodiment, instead of adding region A to the regions list 202 for all retrieved volunteers, the user can specify that information for all volunteers from region B is viewable for all users of the system, regardless of their regions.

In another embodiment of the present invention, the user retrieving volunteer list for region A, can create an emergency, add that emergency to emergencies list 208 for all the retrieved volunteers. This will enable a user associated with that emergency to view this volunteer list. For example, a region A is under a medical emergency. A user, typically an administrator, from another region can then specify one or more volunteers from that region to be available for helping in the emergency. The emergency will then be added to the emergencies list 208 for all the selected volunteers. When these volunteers report at the site of the emergency, the person doing the verification will be able to pull the information of the selected volunteers in order to view or generate their credentials. In another embodiment, instead of adding the emergency to the emergencies list 208 for all the selected volunteers, the administrator can add either the region affected by the emergency to the regions list 202, medical facilities affected by the emergency to the medical facilities list 204 or users administrating or participating in the emergency to the users list 206 for all the selected volunteers.

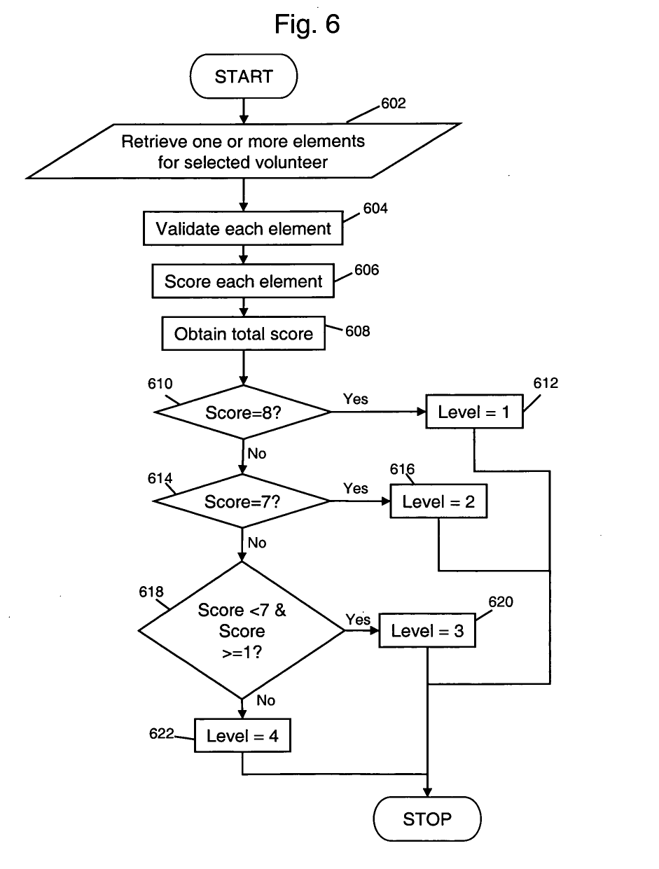

FIG. 6 is a flowchart depicting steps of generating a credential level for a volunteer who is a physician, in accordance with an embodiment of the present invention. At step 602, one or more elements are retrieved for the selected volunteer. These elements can be stored as volunteer details 116 or can be retrieved from an external database. In one embodiment of the present invention, elements are defined by the Health Resource and Service Administration (HRSA) policy and are ESAR-VHP elements. These elements need to be validated to ensure that the information entered by the volunteers for these elements is correct and accurate. Once this information is validated, it does not need to be validated again. The elements are validated in step 604 by an administrator or supervisor. At step 606, each element is scored. This is done on the basis of the response to each element by the volunteer. If the element has a favorable response, a score of one can be associated with that element. Similarly, all elements are scored. In step 608, a total score is obtained for all the elements. In step 610, if the total score is 8 then a credential level of 1 is assigned to the volunteer, in step 612. At step 614, if the total score is 7 then a credential level of 2 is assigned to the volunteer at step 614. At step 618, if the score is lesser than 7 but greater or equal to 1, then a credential level of 3 is assigned to the volunteer at step 620. If the score is 1, then a credential level of 4 is assigned to the volunteer, at step 622. The above steps are in accordance with an embodiment of the present invention. It will be apparent to one skilled in the art that certain modifications will be possible without deviating from the scope of the present invention. For instance, in another embodiment, the total score is generated by taking a weighted average of the scores of the individual elements. In another embodiment, the scoring algorithm varies by profession. FIG. 6 is an exemplary embodiment of the algorithm for calculating the credential score for a physician. In yet another embodiment, if one or more elements have predefined values, then the other elements are not scored, and a total score is assigned on the basis of values of those elements. In another embodiment, the method of calculating the credential score is as specified by ESAR-VHP guidelines.

In an embodiment of the present invention, the credential score is recalculated at a predefined time interval. As time passes, the status of the ESAR-VHP elements may change. This requires the credential score to be updated frequently. The score for the volunteers is recalculated at a specified time interval. In an embodiment, the time interval is specified for each volunteer. In another embodiment, the score is recalculated at a common time interval that is measured from the date for calculation of the score for each volunteer.

In one embodiment of the present invention, the credential information of volunteers is stored in database 112. This database storing the credential information is in accordance with federal guidelines such as ESAR-VHP guidelines, NIMS database guidelines and FIPS-201 guidelines. In another embodiment, the database can exchange information with other databases that are compatible with the above mentioned federal guidelines for databases. The exchange of information is carried out by means known in the art, such as by way of example and not limitation by using a web service to interface with external databases.

In another embodiment, data is imported into database 112 from external databases. In one embodiment, this data is not verified or does not have any credential scores associated with it. This data may also not include any ESAR-VHP or FIPS-201 elements. In a second embodiment, the data is in the form of ESAR-VHP or FIPS-201 elements or credential levels that are generated based on these or other guidelines.

In an alternate embodiment, credential and volunteer information stored in database 112 is exported to an external database. In an embodiment, the external database also stores the information such that it is compatible with federal guidelines such as ESAR-VHP, NIMS guidelines and FIPS-201 guidelines.

All modifications and improvements have been deleted herein for the sake of conciseness and readability but are properly within the scope of the following claims. The above mentioned examples are provided serve a purpose of clarifying the aspects of the invention and it will be apparent to one skilled in the art that they do not serve to limit the scope of the invention.

1. A method for providing a credential level of at least one volunteer responding to a medical emergency in a region to a user; the method comprising the steps of:
a. providing access to a database of volunteers;
b. verifying that the at least one volunteer responding to the medical emergency exists in the database of volunteers;
c. confirming a credential level for the at least one volunteer responding to the medical emergency.

2. The method of claim 1, further comprising the step of generating a credential level for the at least one volunteer responding to the medical emergency.

3. The method of claim 2, further comprising the step of regenerating the credential level for the at least one volunteer responding the medical emergency after a predefined time interval.

4. The method of claim 2, wherein the credential level is generated based on ESAR-VHP guidelines.

5. The method of claim 2, wherein the credential level is generated by the user.

6. The method of claim 2, further comprising the step of storing volunteer information in the database.

7. The method of claim 6, wherein the volunteer information is compatible with at least one federal guideline.

8. The method of claim 7, wherein the guideline is ESAR-VHP.

9. The method of claim 7, wherein the guideline is NIMS.

10. The method of claim 6, wherein the volunteer information is stored with access rights specifying at least one region that can access the volunteer list and volunteer information.

11. The method of claim 10, further comprising the step of providing the at least one region with access rights to volunteer list of a second region, the at least one region not initially being specified to access the volunteer list of the second region.

12. The method of claim 6, further comprising the step of generating an identification badge based on the volunteer information and the credential level of the at least one volunteer responding to the medical emergency.

13. The method of claim 1, further comprising the step of selecting a list of volunteers, from the database of volunteers that can respond to the medical emergency, to be activated.

14. The method of claim 13, wherein the step of verifying that the at least one volunteer responding to the medical emergency exists in the database of volunteers further comprises verifying that the at least one volunteer is in a list of activated volunteers for that medical emergency.

15. The method of claim 13, wherein the step of selecting a list of volunteers from the database of volunteers that can be activated during the medical emergency is based on the access rights of the region where the medical emergency has taken place.

16. The method of claim 15, wherein the access rights of the region further comprise access rights associated with the list of volunteers based on the medical emergency.

17. The method of claim 15, wherein the access rights of the region further comprise access rights associated with the list of volunteers based on the a time period specifying access to the list.

18. The method of claim 13, wherein the step of selecting a list of volunteers that can respond to a medical emergency is on the basis of a volunteer criteria for each volunteer from the list of volunteers.

19. The method of claim 18, wherein the volunteer criteria is selected from the group consisting of: profession, specialty, credential level, training level, education level, region, zip code, and combinations thereof, all associated with the volunteer.

20. The method of claim 1, further comprising the step of providing a registry of volunteers from the database, the registry having a list of volunteers and being compatible with ESAR-VHP.

21. The method of claim 1, further comprising the step of providing a registry of volunteers from the database, the registry having a list of volunteers and being compatible with NIMS.

22. A method for providing at least one volunteer at the site of a medical emergency in a region, the method comprising the steps of:
a. storing volunteer information in a database, the volunteer information stored along with access rights specifying at least one other region that can access the information;
b. sending a request to at least one volunteer from the list of volunteers that can be accessed by the region of the medical emergency to report at the site of the medical emergency;
c. the at least one volunteer responding to the request by being present at the site of the medical emergency;
d. generating a credential level of the at least one volunteer that has responded to the request.

23. The method of claim 22, further comprising the step of generating an identification badge based on credential level and volunteer information.

24. The method of claim 22, wherein the volunteer information is compatible with ESAR-VHP guidelines.

25. The method of claim 22, wherein the step of generating a credential level is based on ESAR-VHP guidelines.

26. A method for providing at least one volunteer at the site of a medical emergency in a region, the method comprising the steps of:
a. storing volunteer information in a database of volunteers, the volunteer information stored along with access rights specifying at least one other region that can access the volunteer information;
b. generating and storing a credential level for the at least one volunteer;
c. providing the region affected by the medical emergency access to a list of volunteers, the list of volunteers generated from the database of volunteers, the region not initially having access rights to the list of volunteers;
d. sending a request to at least one volunteer from the list of volunteers, to report at the site of the medical emergency;
e. the at least one volunteer responding to the request by being present at the site of the medical emergency;
f providing a credential level of the at least one volunteer that has responded to the request.

27. The method of claim 26, further comprising the step of generating an identification badge based on credential level and volunteer information.

28. A method for generating a credential level for at least one volunteer responding to a medical emergency, the method comprising the steps of:
a. receiving information about the at least one volunteer from a database storing said information; the information comprising at least one element of ESAR-VHP elements;
b. calculating a score for the at least one element to obtain an individual score;
c. combining at least one of the individual scores to obtain a final score;
d. comparing the final score to predetermined threshold levels to obtain a credential level;
e. providing the calculated credential level for generating an identification badge, the identification badge communicating the credential level.

29. The method of claim 28, wherein the step of combining the individual scores further comprises the step of summing the individual scores.

30. A system for providing a credential level to at least one volunteer responding to a medical emergency in a region, the system comprising:
a. at least one server having a first database; the first database storing a list of volunteers;
b. at least one client for accessing the database, the client retrieving at least one volunteer information and providing a credential level;
c. a network connecting the server and the client.

31. The system of claim 30, further comprising an access control module for controlling access to the volunteer information.

32. The system of claim 31, wherein the at least one server further comprises a second database having a list of regions that can access volunteer information for the at least one volunteer information stored in the first database.

33. The system of claim 32, wherein the access control module checks the second database to verify that the client retrieving volunteer information is associated with at least one region having access to the requested volunteer information.

34. The system of claim 30, wherein the network is selected from a group comprising of wired network, wireless network, mobile network and combinations thereof.

35. The system of claim 30, wherein the client is selected from a group comprising of a personal computer, a PDA, a mobile phone device, a laptop computer.

36. A method for providing a credential level of at least one respondent responding to a medical emergency in a region to a user; the method comprising the steps of:
a. providing access to a database of respondents;
b. verifying that the at least one respondent responding to the medical emergency exists in the database of respondents;
c. confirming a credential level for the at least one respondent responding to the medical emergency.
